(19) United States
(12) Patent Application Publication
(10) Pub. No.: US 2026/0368550 A1
(43) Pub. Date: Nov. 19, 2026

(54) GENERATING KNOWLEDGE GRAPHS

(71) Applicant: Chevron U.S.A. Inc., San Ramon, CA (US)

(72) Inventors: Fiona Qiong ZHANG, Katy, TX (US); Keith Stanley JOHNSTON, Sugar Land, TX (US); Joshua Perryman, Houston, TX (US)

(21) Appl. No.: 19/135,529

(22) PCT Filed: Dec. 5, 2023
(86) PCT No.: PCT/US2023/082616

§ 371 Date: Jun. 4, 2025

Related U.S. Application Data
(60) Provisional application No. 63/430,253, filed on Dec. 5, 2022.

(51) Int. Cl. G06N 5/022; G06F 16/901; G06F 16/9038

(52) U.S. Cl. CPC G06N 5/022; G06F 16/9024; G06F 16/9038

(57) ABSTRACT

A method is described for generating a multi-tier facility knowledge graph for a facility. The method comprises obtaining P&ID data for the facility and generating a P&ID knowledge graph responsive to the obtained P&ID data for the facility. The P&ID knowledge graph serves as an originating P&ID tier in the multi-tier facility knowledge graph for the facility. The method comprises obtaining physical asset data for the facility and generating a physical asset tier responsive to the obtained physical asset data for the facility. The method comprises connecting the physical asset tier and the P&ID tier to update the multi-tier facility knowledge graph for the facility, wherein the P&ID tier comprising the P&ID knowledge graph serves as a control structure for the multi-tier facility knowledge graph.

### CROSS-REFERENCE TO RELATED APPLICATIONS

This application claims priority to U.S. Provisional Patent Application Ser. No. 63/430,253, titled “Generating Knowledge Graphs” and filed on Dec. 5, 2022, the entire contents of which are hereby incorporated by reference.

### STATEMENT REGARDING FEDERALLY SPONSORED RESEARCH OR DEVELOPMENT

Not applicable.

### TECHNICAL FIELD

The disclosed embodiments relate generally to techniques for generating a multi-tier facility knowledge graph.

### BACKGROUND

Facilities are utilized in many industries such as in the hydrocarbon industry. A physical facility generally manages the use, processing, storage, manufacturing, handling or movement of oil and gas feedstock and products or by-product. However, facility data, such as data in and around the design and operation of a facility (e.g., an oil and gas facility), is traditionally siloed and dispersed among multiple source systems. There exists a need for to improve access to data of a facility.

### SUMMARY

In accordance with some embodiments, a method is described for generating a multi-tier facility knowledge graph for a facility. The method comprises obtaining P&ID data for the facility and generating a P&ID knowledge graph responsive to the obtained P&ID data for the facility. The P&ID knowledge graph serves as an originating P&ID tier in the multi-tier facility knowledge graph for the facility. The method comprises obtaining physical asset data for the facility and generating a physical asset tier responsive to the obtained physical asset data for the facility. The method comprises connecting the physical asset tier and the P&ID tier to update the multi-tier facility knowledge graph for the facility, wherein the P&ID tier comprising the P&ID knowledge graph serves as a control structure for the multi-tier facility knowledge graph.

In accordance with some embodiments, a system is described. The computer system, comprising: one or more processors; memory; and one or more programs, wherein the one or more programs are stored in the memory and configured to be executed by the one or more processors, the one or more programs including instructions that when executed by the one or more processors cause the system to generate a multi-tier facility knowledge graph for a facility. The method comprising obtaining P&ID data for the facility and generating a P&ID knowledge graph responsive to the obtained P&ID data for the facility, wherein the P&ID knowledge graph serves as an originating P&ID tier in the multi-tier facility knowledge graph for the facility. The method comprising obtaining physical asset data for the facility and generating a physical asset tier responsive to the obtained physical asset data for the facility. The method comprising connecting the physical asset tier and the P&ID tier to update the multi-tier facility knowledge graph for the facility, wherein the P&ID tier comprising the P&ID knowledge graph serves as a control structure for the multi-tier facility knowledge graph.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates a non-limiting example of a computer system for use with embodiments of the instant disclosure.

FIG. 2 provides a high-level business process overview from system of origin data to the development of a multi-tiered knowledge graph.

FIG. 3 illustrates non-limiting tiers that are layered onto the P&ID core design tier to develop the multi-tiered facility knowledge graph.

FIG. 4 illustrates both a single uniqueness relationship and multiple uniqueness relationships.

FIG. 5 illustrates the connection of the multi-tiers to the foundational P&ID tier.

FIG. 6 illustrates the non-limiting system of networks which comprise each tier building out the multi-tier facility knowledge graph.

FIG. 7 illustrates an example process 700 of generating a multi-tier facility knowledge graph for a facility.

FIG. 8 illustrates a non-limiting example of the P&ID depicting a pump with some valves and instruments.

FIG. 9 illustrates a non-limiting example of the P&ID tier based on the P&ID in FIG. 8.

FIG. 10 illustrates a non-limiting example of the physical asset tier based on the P&ID in FIG. 8.

FIG. 11 illustrates an example of multiple relationships, defining multiple networks, connecting two nodes in a physical asset tier.

FIG. 12 illustrates a non-limiting example of a multi-tiered facility; knowledge graph with a P&ID tier (top) and a physical asset tier (bottom) connected by tag to physical asset relationships.

FIG. 13 illustrates a non-limiting example of an instrument network with control loops (IPS, DCS) represented as a knowledge graph.

Like reference numerals refer to corresponding parts throughout the drawings.

### DETAILED DESCRIPTION OF EMBODIMENTS

Described below are methods, systems, and computer readable storage media that provide a manner of generating a multi-tier facility knowledge graph for a facility. For example, a computational knowledge graph technology centered on the P&ID and extending through to other types of facility data representations (e.g., asset hierarchy, process simulations, etc.) may be generated that supports the analysis that engineers and other subject matter experts regularly perform across multiple computer systems for the design, maintenance, and operation of a facility (e.g., an oil & gas facility).

Traditionally, the records of disparate systems, like Piping and Instrumentation Diagrams (P&IDs), Process Flow diagrams (PFDs), equipment datasheets, etc. are represented as document deliverables, and the databases are not leveraged by end users. The actual data is encapsulated within a document abstraction, increasing the costs to access and to utilize the data.

Indeed, facility data, such as data in and around the design and operation of a facility (e.g., an oil and gas facility), is traditionally disperse in implementation. In one example, there may be at least thirty (30) technology domains, systems, and tools required for a facility. These tools tend to be siloed, focusing on a single persona or specific type of problem. Exploring the myriad of systems supporting just one facility, there are different phases of work spanning design, construction, operation, and retirement; there are different roles and personas from multiple engineering disciplines (chemical, process, mechanical, instrumentation, electrical) to various other operator roles and other support staff. Even simple domain artifacts, such as a pump, will have widely varying representations from one system to another, with some systems recording physical characteristics (material dimensions, voltage requirements), while others have functional characteristics (revolutions per minute, flow rates) or other datum (last maintenance date, spare parts vendor). In addition, each system seems to have its own lifecycle for tracking entities, and these different lifecycles are not easily reconciled.

During facility operations, the need to interact with multiple systems of record, aggregate their information, and reconcile their data against one another oftentimes proves to be time consuming and error prone because the operations are often performed manually as ad hoc responses to situational requests. As a result, multiple checks and validations are instituted through processes and procedures to ensure safe and reliable operation of the facility. But even with all of this data, all of these systems, and copious procedural documentation, the operation of the facility still depends on vast information only available in the minds and memories of the staff. This expertise, derived from both education and experience, is sometimes not materialized in the data in usable or useful fashion.

Advantageously, embodiments consistent with this disclosure may reduce (or even remove) the deleterious document boundary and free the datum within to be encoded in a more easily queried format and to be linked with each other and with other data for ever-increasing value creation. Advantageously, embodiments consistent with the disclosure may integrate multiple siloed data sources, at varying levels of abstraction, and with differing levels of detail, even different taxonomies, and combine them with the not-yet-encoded-in-data expertise of multiple occupational disciplines into one efficient facility knowledge management system using a multi-tier facility knowledge graph. The multi-tier facility knowledge graph may reduce the time required to reason over the complexity of a facility (e.g., an oil and gas facility), provides re-usable functionality which may be tested and validated reducing errors and spurring new optimizations & insights, and/or encodes domain knowledge not currently in existence in any other data system, thereby improving safety and enhancing decision-making quality and speed.

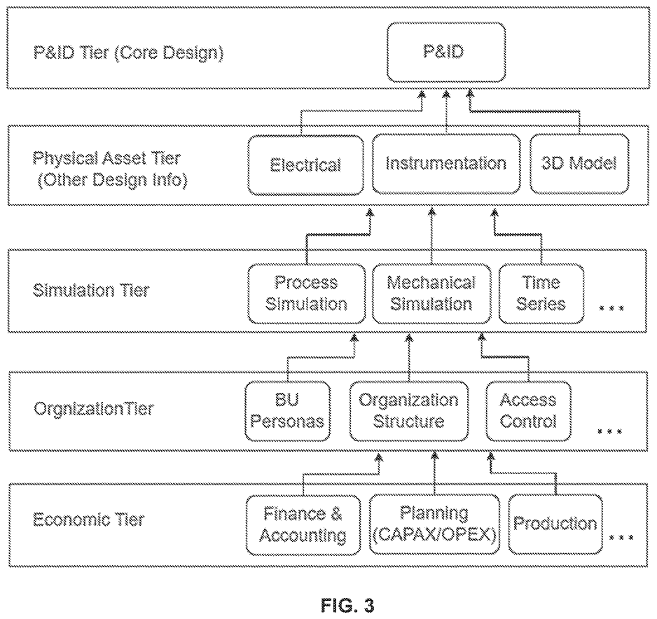

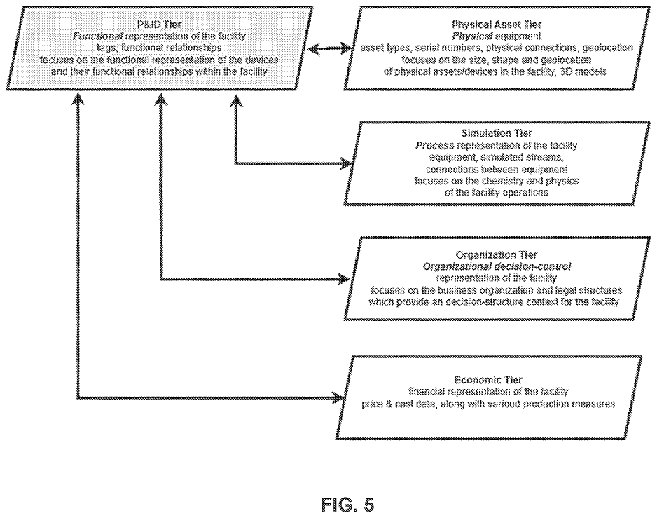

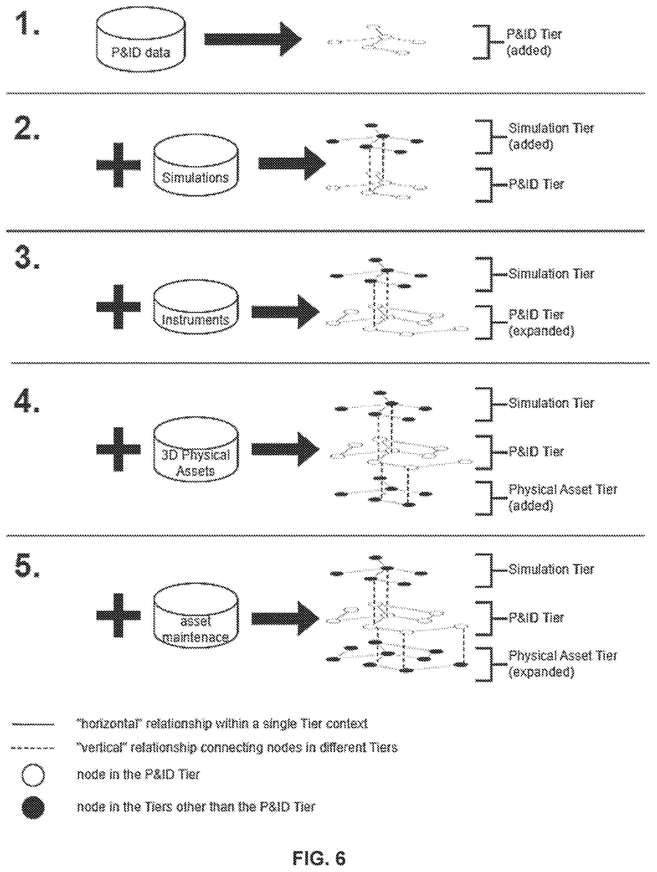

FIG. 3, FIG. 5, and FIG. 6 illustrate a non-limiting example of a multi-tier facility knowledge graph having five tiers and illustrates the type of data corresponding to each tier. A computational knowledge graph technology centered on the P&ID and extending through to other types of facility data representations (e.g., asset hierarchy, process simulations, etc.) may support the analysis that engineers and other subject matter experts regularly perform across multiple computer systems for the design, maintenance, and operation of a facility, such as an oil & gas facility.

Some embodiments include converting the P&ID documents and data into the first tier of the multi-tier facility knowledge graph. Then the P&ID tier is expanded in multiple directions with records from source systems. For systems whose data is at the same abstraction level as the P&ID data, the graph is expanded horizontally to enhance the existing functional description of the facility. For systems which operate in distinctly different domains, or at distinctly different abstraction levels, a new tier may be established, and then vertically connected to the tier based on the P&ID data. The P&ID serves as the main control structure and central binding point for all data added to the knowledge graph because it is the core functional representation of the facility to which all other data can be bound.

Maintaining the multi-tier facility knowledge graph includes taking the terminology and taxonomy of the source systems and translating them into a multi-tier facility knowledge graph as a single, but multi-tiered, taxonomy. Lineage is established connecting back to the source data systems, which provides traceability and ensures data quality. As illustrated in the figures, the P&ID data starts the foundation tier of the multi-tiered graph, is extended vertically through the addition of a simulation tier (below at step 2) and physical asset tier (below in step 4). Also, each of the tiers may be extended horizontally, like in step 3 where instrument control loops were added to the P&ID data and at step 5 where maintenance records are added to the asset hierarchy.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

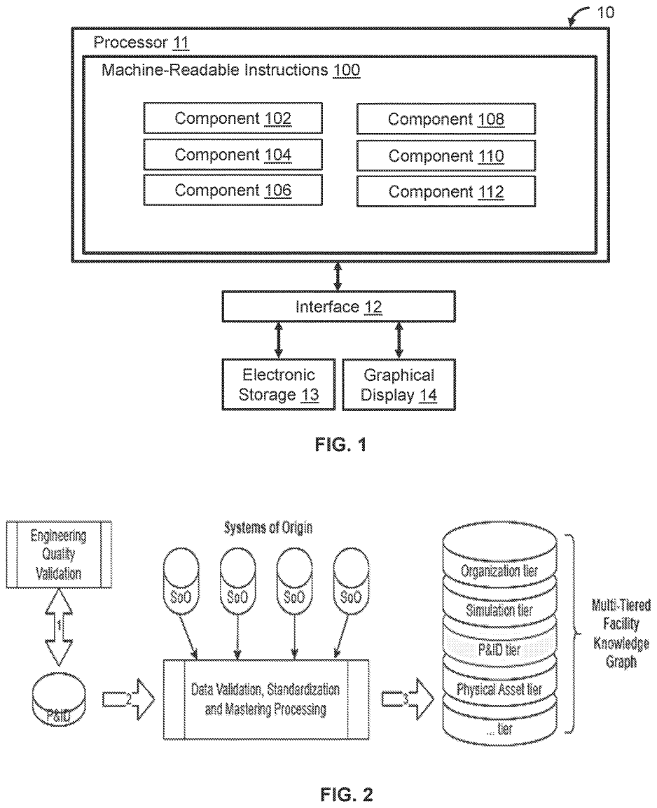

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components. The processor 11 may perform a method of generating a multi-tier facility knowledge graph for a facility, including inputs such as P&ID data, physical asset data, simulation data, organization data, economic data, queries, and/or other input data, as well as output such a generated multi-tier facility knowledge graph, a query result, and/or other output data.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to input such as P&ID data, physical asset data, simulation data, organization data, economic data, queries, and/or other information. For example, the electronic storage 13 may store information relating to output such a generated multi-tier facility knowledge graph, a generated query result, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to output (e.g., intermediate & final results) such as a generated P&ID tier, a generated physical asset tier, a generated simulation tier, a generated organization tier, a generated economic tier, a generated multi-tier facility knowledge graph, a generated query result, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate generation of a multi-tier facility knowledge graph. The machine-readable instructions 100 may include one or more computer program components. The machine-readable instructions 100 may include an obtain data component 102, a process data component 104, a knowledge graph tier generation component 106, a multi-tier facility knowledge graph generation component 108, a query component 110, a display component 112, and/or other computer program components. These components may execute the functionality described herein.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Turning more specifically to the obtain data component 104 and the process data component 106, it is worth noting that a data processing step may be applied to obtained data before generating the corresponding knowledge graph tier responsive to that obtained data. A first “engineering data quality of the P&ID data” check may be formed and a second data validation & mastering check may be performed that may happen when combining the data and building the different tiers, as explained further in FIG. 2. The data processing step may be performed on the P&ID data obtained from a data store, the physical asset data obtained from a data store, the simulation data obtained from a data store, the organization data obtained from a data store, the economic data obtained from a data store, and other data obtained from a data store for generating a more accurate multi-tier facility knowledge graph for the facility. The data store may be a database, a system of record, a system of origin, etc.

FIG. 2 illustrates one embodiment of a data processing that may be useful before constructing the multi-tier facility knowledge graph. Turning to data quality and engineering, the P&ID data for the facility and the P&ID tier responsive to the P&ID data for the facility serve as the control structure in the construction of the multi-tier facility knowledge graph. This establishes the core of the multi-tier facility knowledge graph as the functional representation of the facility. All other data source for any other domain or abstraction level may be incorporated into the multi-tier facility knowledge graph in conjunction with the P&ID data. Data standardization and normalization processes, which resolve or master the data, may harmonize all other data sources with the P&ID data in the construction of the multi-tier facility knowledge graph.

The data quality of the P&ID data is important to data harmonization processes and other data integration efforts which will follow. Data quality verification processes, which utilize a multitude of strategies for ensure correct and usable P&ID data, may also be utilized. These strategies run from simple data validation checks to complex analysis driven by business rules concerning engineering quality.

For example, an effective data check that may be performed may be a check for isolated or “orphaned” data within the P&ID database. It may be taken as a given that every functional part of the facility is connected to other functional parts of the facility. If something is not connected to other parts of the facility then either it is an ornamental adornment, or it is under construction in anticipation of a future connection. Therefore, if a portion of the P&ID data is isolated from the rest of the P&ID data, a data quality problem has been identified in some embodiments. Of note, connections may be made through asynchronous functionality such as shipping containers. Even items which are not continuously connected temporally may be functionally connected in the P&ID tier, like a shipping container is occasionally parked at a shipping and receiving bay.

In another example, a business rule based on engineering best practices states that control valves should not be placed in sequence with one another. A design which has control valves in sequence may result in a facility that is more complex to operate. However, due to the complexity and density of the information contained within P&ID diagrams, a visual inspection of the P&ID diagrams may struggle to determine if two control valves are in sequence given that they may not be in physical proximity to one another on the P&ID diagrams and may have multiple passive devices interspersed in the connections between them. As such, as provided herein, a data rule that analyzes the P&ID data by traversing through the P&ID database connections may quickly identify control valves in sequence.

These are two examples of many possible rules and validations that may be performed on the P&ID data so that it may serve as the control structure for all other connected data. Without these assurances for both the engineering quality and the data quality, the core of the multi-tier facility knowledge graph may become suspect and undermine the usefulness of the of the multi-tier facility knowledge graph.

Turning to harmonized data and source authority levels requirements, source systems (e.g., databases, systems of origin, systems of records, etc.) may have different taxonomies. These taxonomies may be based on published standards or may be the unique and independent creation of the system designers. The instant disclosure addresses this challenge by instituting multiple tiers in the multi-tier facility knowledge graph. Each tier is based on a synthesis of related systems and their taxonomies, for example, utilizing published standards (e.g., ISO 19008, ISO 14224, CFIHOS, ISO 81346, Data Exchange in the Process Industry (DEXPi), etc.) to define a tier's taxonomy, and as explained herein, governed by the P&ID tier created from the P&ID data (e.g., validated and harmonized/mastered P&ID data).

Attempts to integrate data from multiple sources without first performing a mastering operation to de-duplicate entities and relationships, and assert/maintain their uniqueness, may make composition and usage of the multi-tier facility knowledge graph more difficult. Indeed, each source system typically uses its own taxonomy or has its own domain. However, the multi-tier facility knowledge graph, as explained herein, may be designed to be a multiple domain knowledge graph for the facility that represents multiple aspects of the facility (e.g., represents all aspects of the facility).

Combining data from the various source systems without first mapping into a common domain may result in a data store that is significantly more complex and costly to use. For example, integration of data from various source systems may result in conflicts. These may be simple temporal dislocation, such as system A is updated before system B. They may also be from transcription or other isolated permutation errors, which differ from the ground truth of the facility.

The tier level will address the conflicts between different systems. For the same object, if any different representation, naming or tagging, the top tier (P&ID tier) always prior data from other tiers. If P&ID doesn't have the object information, the information for the second tier (physical asset tier) will dominate the information from the rest of tiers, then simulation tier, then business organization tier, and then economic tier, as illustrated in FIG. 3. Note that it may be sufficient to perform the mappings at the entity and relationship level. Though attributes or properties should be standardized, except for the uniqueness requirement for primary keys, a multiplicity of properties or their values may be supported (and sometimes desired). Entities, however, should be resolved uniquely and the different representations of a unique entity in the source systems should be mapped into an authoritative or “golden” record.

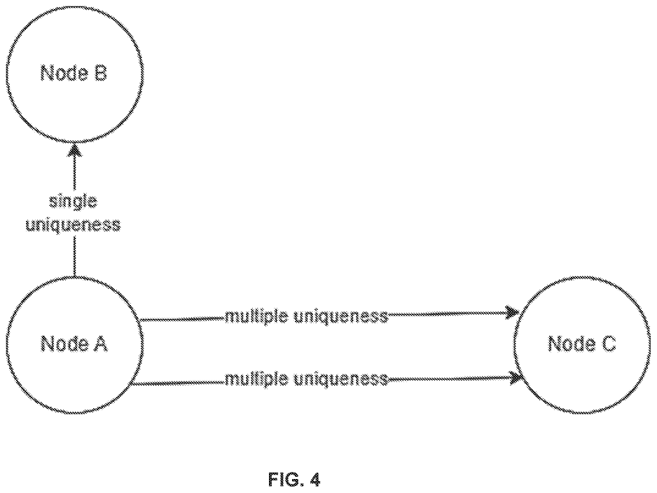

The matter is marginally muddied with relationships, also known as edges or links in graph terminology, as they may have an acceptable uniqueness level in the target domain. The uniqueness describes the number of times that an instance of an entity (a single node in a graph) may be related in a single, specific way to an instance of another entity. Uniqueness may either be single or multiple and may be specific to both the type (or label) of the nodes, and the type (or label) of the relationship. In short, sometimes multiple relationships of the same type may exist between two nodes in the multi-tier facility knowledge graph, but there should only be a single node for a unique entity, as illustrated in FIG. 4. FIG. 4 illustrates some uniqueness approaches. The connection between Node A and Node B may only have one “single uniqueness” relationship, but between Node A and Node C, it is possible to have more than one “multiple uniqueness” relationships.

Turning more specifically to the knowledge graph component 108 and the multi-tier facility knowledge graph component 110, with the data ingestion of the and processing functionality covered by the obtain data component 104 and the process data component 106, respectively, the design of the multi-tier facility knowledge graph will be discussed in some detail.

Foremost, a facility is a physical installation, whether surface or subsea, that includes the system and equipment to support the production, processing, transmission, distribution, storage of hydrocarbon products, within the battery limits. The structures required for these operations, and the operations themselves, may be very complex. They are described in various ways by various disciplines using various levels of abstraction, but they may be associated to the P&ID as discussed herein using tiers. Five tiers describing the facility are discussed herein, but the number of tiers in the multi-tier facility knowledge graph is not limited to five. As illustrated in FIG. 3 and FIG. 5, the five tiers are: P&ID tier, physical asset tier, simulation tier, organization tier, and economic tier. FIG. 3, FIG. 5, and FIG. 6 illustrate views of multiple tiers and type of data corresponding to each tier. Each tier has a different level of abstraction and a differentiated focus from the other tiers.

The P&ID tier is centered on P&ID data as the control structure. This is the tier to which all other tiers will connect as it describes the purpose and function for the components in the facility. This tier is not directly concerned with the physical descriptions of the facility components, and for example, a one-inch line on the P&ID could represent a signal wire a few inches long or a pipe that is hundreds of feet long. Nor is it directly concerned with the chemistry or physics, though it may include attributes which convey functional requirements, such as pressure limits on a vessel or rotational speed minimums on a pump. The P&ID tier is the originating tier for the multi-tier facility knowledge graph.

The physical asset tier starts with the asset catalog and is focused on the physical description and geolocation of the physical assets. Also included at this level are any datum specific to the physical assets themselves, such as maintenance records, manufacturer documentation and recommendations, and any measurements taken from the physical assets.

The simulation tier is based on process flow diagrams and simulation software, elements of the simulation tier focus on accurately modeling the physics and chemistry of the facility. This simulation tier may also include elements which are not present in the facility and are not included in other tiers in order to service the requirements of simulation software models.

The organization tier is based on a corporation's legal business units and departmental organization structure, and models the ownership and decision pathways with the business itself.

The economic tier is based on economic data, such as, but not limited to, finance and accounting, planning such as capex and opex, production from the facility (e.g., hydrocarbon production from the facility), and the like.

While tiers are the top-level approach for introducing federation in the multi-tier facility knowledge graph, the facility data is sufficiently complex (over 30 different domains) that further federation may be utilized. Within a tier, additional “networks” may be defined. For example, in the P&ID tier, the primary network may be based on the P&ID data. However, since systems for managing instruments operate at the same level of abstraction as P&IDs, their additional data elements may be included at the P&ID tier in combination with the P&ID data. The present disclosure is not limited to these five tiers. They serve as a reasonably representative depiction of multiple tiers of abstraction. Within each tier, multiple networks may be contained, and these networks, as well as their inter-connections, may exist between tiers as well. The multi-tier facility knowledge graph may be considered to be, not just a graph of graphs, but a graph of graphs of graphs.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

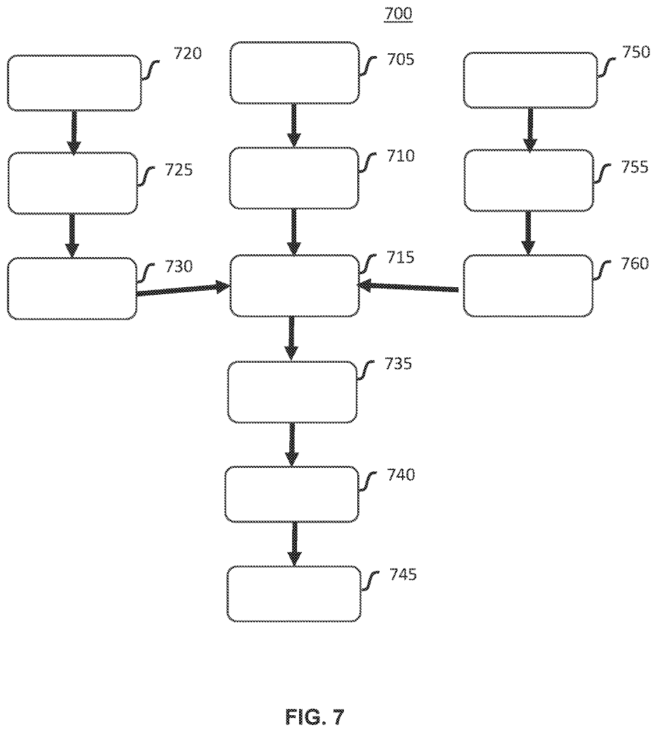

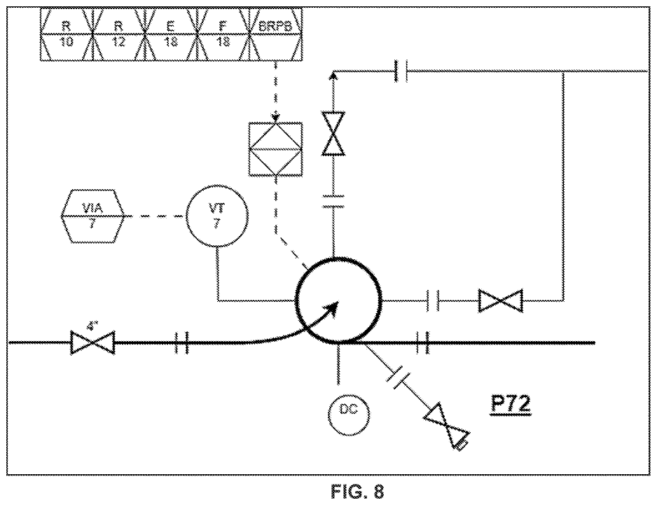

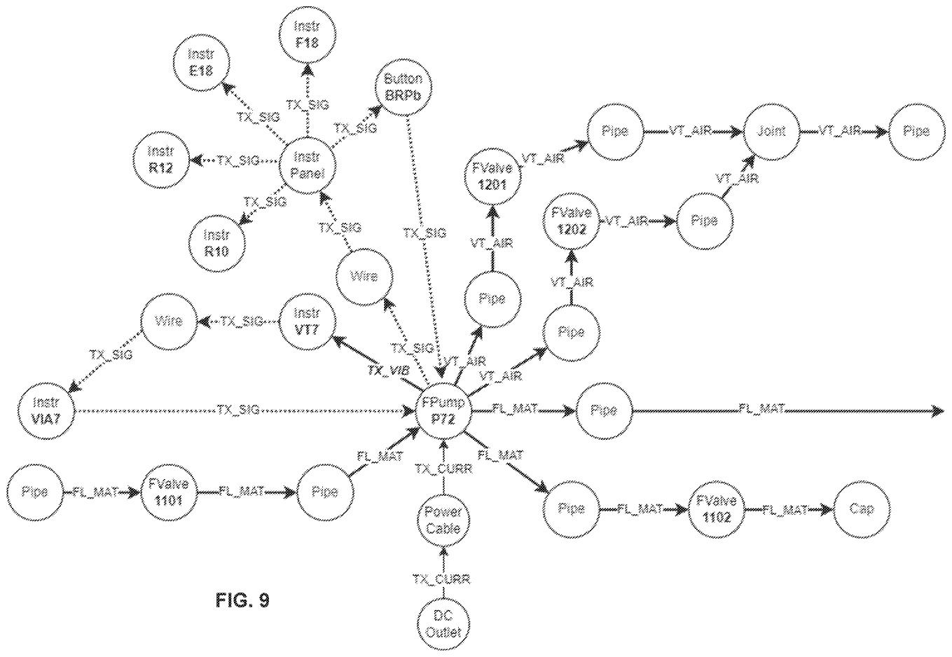

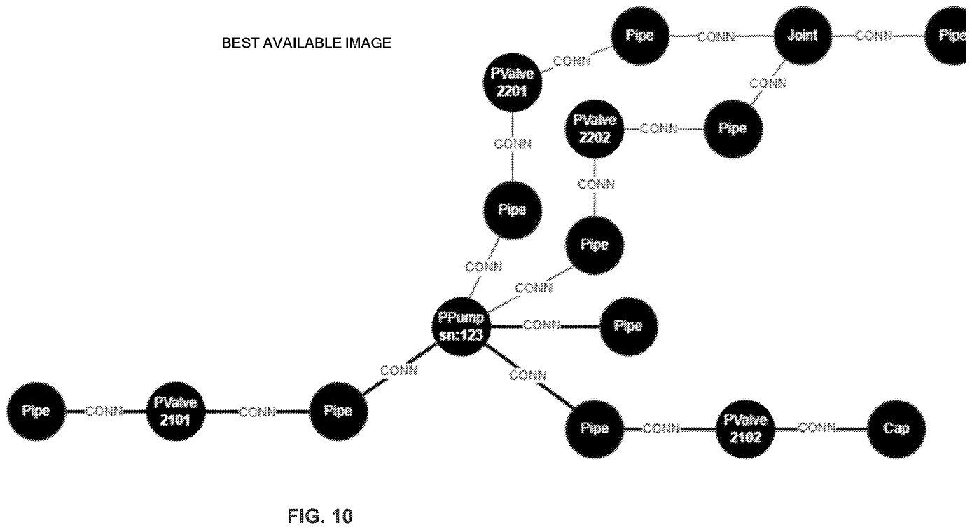

FIG. 7 illustrates an example process 700 of generating a multi-tier facility knowledge graph for a facility. At step 705, the method 700 obtaining P&ID data for the facility and generating a P&ID tier responsive to the obtained P&ID data for the facility. The P&ID tier serves as an originating tier in the multi-tier facility knowledge graph for the facility. This operation is a transformation and possible extension of the data encoded from the P&ID. For data entities. they will become nodes in the knowledge, often with a translation from a source domain into the ontology of the P&ID tier. The existing links or relationships in the P&ID are also translated into a specific relationship ontology to accurately represent the functional details of the P&ID which often require an engineer to determine or interpret. Note that lines on the P&ID represent piping components. For the P&ID tier, pipes may be implemented as nodes within the graph and are then connected with relationships to the valves or other equipment nodes as translated from the P&ID. As will be explained hereinbelow, the multi-tier facility knowledge will comprise a P&ID tier comprising the P&ID tier. The P&ID data may include equipment, valves, piping components and other annotations from the diagrams. FIG. 8 illustrates a non-limiting example of a P&ID of a pump of a facility. FIG. 9 illustrates a non-limiting example of a P&ID tier consistent with the P&ID diagram of FIG. 8.

A particular P&ID diagram represents the functional equipment (e.g., pump, pipes, valves) and their connections. The particular P&ID diagram also depicts instruments connected to the equipment, as well as valves and other flow modulation or control devices. P&IDs are the starting and ending points for understanding how a facility is designed to operate. A cursory view of the P&ID schematic of the FIG. 8 illustrates that it is an information-dense diagram that communicates information to multiple engineering disciplines and domains, and, that much of that information is provided in the connections or relationships between the equipment and then how these are grouped into systems, the systems into plant units and the plant units into process facilities.

However, P&ID diagrams are also abstract depictions of a physical construction. For example, a line drawn a few inches long on a P&ID may represent a pipeline that either is hundreds of feet long or just a few feet in length, since P&IDs are not drawn to scale. Also, P&IDs are not always explicit regarding other important characteristics of the connections, such as their direction, various measures of magnitude (e.g., rate of flow, voltage, etc.), and/or the composition of a connection's contents. For example, lines may represent a pipeline carrying hydrocarbon material, or it may represent a conduit with a copper wire carrying a digital signal. The line depiction is read in conjunction with multiple other text like piping codes or supplemental data like data sheets to understand and interpret its significance in the facility design.

With training and experience, a user may be able to decipher the connections in a P&ID diagram, including determining direction of flow, size, material of construction, and other characteristics, and even the general properties of the content which flows within the pipes or is being processed by equipment. But a facility may have hundreds to thousands of P&IDs, and this approach to deciphering a P&ID is labor intensive, inefficient, and potentially inconsistent as it is based on user experience and interpretation and often requires referencing many supplemental records. Embodiments consistent with the instant disclosure may reduce this ambiguity by encoding the information from the P&IDs in the nodes and relationships of the P&ID tier, thereby codifying multiple engineering disciplines and many years of subject matter expertise into a knowledge graph.

As explained herein, a facility is a functional environment, and the P&ID data is utilized herein in a P&ID tier to generate a functional representation of the facility. The P&ID tier represented by the P&ID data when converted to a P&ID tier for the facility may contain at least two networks. First is the network which depicts the movement and processing of material through the facility, which is referred to as a MATERIAL_MOVEMENT network herein for simplicity. Second is the network that depicts instruments which monitor, control and sometimes even adjust settings or configurations of the devices in this second network. These instruments convey information through a SIGNAL_TRANSMISSION network herein for simplicity. One skilled in the art of parsing P&ID schematics can easily decipher the symbols to determine which type of relationship should be used to represent a given connection. Since the symbols used on P&IDs are finite and generally universal, it is possible to create a mapping of all the possible combinations of symbols and assign the appropriate type of relationship to each combination.

The many P&ID schematics may be converted into a single P&ID tier as follows. The nodes of the P&ID tier may be labeled as pump, vessel, pipe, valve. TABLE_1 below may be utilized for the relationships of the P&ID tier. The non-limiting example of the P&ID tier in FIG. 9 illustrates the conversion from the P&ID of FIG. 8 using the nodes of pump, DC outlet, pipe, valve, instrument, wire and the relationships of TABLE_1.

TABLE 1
Relationships in a P&ID tier:

FL_MAT: flow materials, flow of fluid or gas through a pipeline
TX_CURR: transmit current, power transfer through electric current
TX_SIG: transmit signal as information through an electric current
TX_VIB: transmit vibration
VT_AIR: ventilate air

The P&ID of interest (e.g., substantially all P&ID schematics for the facility, substantially all P&ID schematics for a subsystem of the facility, etc.) may be converted into a single P&ID tier. The multi-tier facility knowledge comprises the functional tier comprising the P&ID tier. For example, two thousand P&ID schematics of interest for a facility_1 may be converted into a P&ID tier for the facility_1. The multi-tier facility knowledge graph for the facility_1 comprises the P&ID tier for the facility_1. The P&IDs of interest may be selected by a user via a graphical user interface and/or in an automated manner.

In a use case, if an instrument displays an unexpected value, a user may have to manually trace the material movement connections in one or more P&ID schematics to a place where instruments are showing expected values and try to isolate the location of disturbance by analyzing multiple datasets for that instrument. However, a P&ID tier, such as described herein, that encodes the P&ID with the details of the networks (e.g., the MATERIAL_MOVEMENT network and the SIGNAL_TRANSMISSION network), including edges with different types or labels, and with direction, may support a data-centric analysis to the problem by linking all the available data for that instrument to the context of its location on the instrument in the P&ID functional tier. With a data-centric analysis, the user may have a pre-designed data query or function, which would take the alerting instrument as an input and return the likely source of the problem as an output. This data-centric solution based on the P&ID tier may be faster and less prone to error than the user's manual analysis which depends on experience of performing this task as well as access to relevant information.

The P&ID tier in the multi-tier facility knowledge graph is a succinct expression of the functional design of the facility and positioned to be a control structure for the other tiers in the multi-tier facility knowledge graph. For conversion, the primary element of the P&ID tier is a construct called a tag, which is a label applied to elements of the P&ID diagrams so that they may be associated with the physical assets of the facility. By creating a “tag to physical asset” relationship in the P&ID tier, the P&ID tier is connected with the physical asset tier. Through the connected nature of the P&ID tier, these relationships may be traversed and the functional designations of the P&ID diagrams combined with the representations of the physical assets in the physical tier, and bring a clear functional understanding to the physically connected assets. Through this tag-to-physical asset connection, not only is the functional capability illustrated, but specific analysis such as flow direction and composition of materials present in the functional tier may be readily extended into the physical tier, thereby enhancing the depiction of the physical assets with important contextual information.

At 710, the method 700 comprises obtaining physical asset data for the facility and generating a physical asset tier responsive to the obtained physical asset data for the facility. As will be explained hereinbelow, the multi-tier facility knowledge graph will comprise a physical tier. The physical asset data may include the three-dimensional models (3D Model) relationship for the physical representation of the facility. The data contained in 3D model databases may be connected to as a tier to the P&ID tier and will enable the data related to the size, dimension, geospatial location, orientation and layout of parts and equipment to be networked to the P&ID tier. FIG. 10 illustrates a non-limiting example of a physical asset tier based on the P&ID in FIG. 8. In FIG. 10, the physical asset tier for a P&ID, the relationships all depict connections to/from pipes, the thicker edges represent larger or more robust pipes for moving liquid material, and the thinner edges represent less robust pipes for moving gas/air/exhaust. Note that there are no arrowheads because physical connectivity is directionless.

The facility, such as an oil and gas facility, may be viewed as a physical construct. The facility is composed of devices, parts, equipment, and systems with specific physical dimensions and the physics of the facility is fundamental to its safe and efficient operation. As mentioned above, P&IDs include abstraction. But the corresponding digitized P&ID of the P&ID tier may be connected to a physical tier, such that the physical tier is a digital physical representation of the physical assets of the facility.

The physical asset tier represented by the physical asset data, when converted to a physical asset tier for the facility, contains at least two networks, an asset hierarchy network and a physical connections network. Focusing on the physical asset hierarchy network, certain systems of record keep track of physical assets (e.g., Asset Registers, Asset Framework) in a “bill of materials” manner, representing that a physical asset is composed of several sub-physical assets. This may be as detailed as depicting individual bolts. Individual bolts and screws may not be necessary in a physical asset tier, but pipes and valves along with the other major equipment and devices would be included in a physical asset tier.

In addition to the physical asset hierarchy, the physical asset tier also depicts what physical assets are physically connected to one another and the precise geospatial location of those connections. This ability to depict (e.g., in all dimensions) the physical assets is both valuable and traditionally limited. A traditional digital representation of a facility may be rendered on a computer screen, or in a virtual reality environment. However, this traditional physical representation may not indicate the functional purposes of the physical assets or even something as simple as direction of flow of materials in the pipes. In contrast, the physical asset tier is connected to the P&ID tier as explained herein. By connecting these two tiers, the user may see the physical dimensions of the physical assets, which are not depicted on P&IDs, and may overlay the functional intent of the design, which is not depicted in the physical asset hierarchy or other artifacts (e.g., a 3D models).

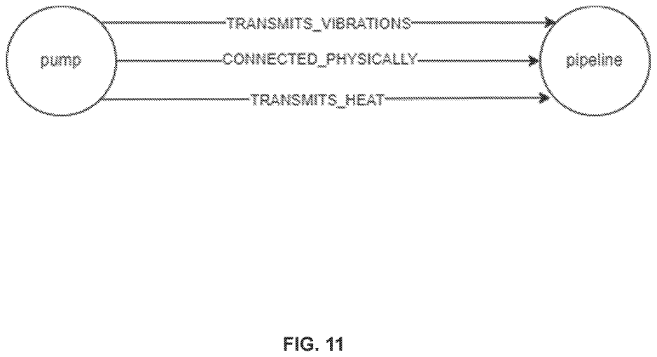

There is another capability in the physical asset tier related to the modeling of certain “natural phenomena networks.” Because the physical asset tier has the physical dimensions, geospatial coordinates, and therefore the ability to reason over proximity (e.g., this pipe is connected to this pump, those pipes are separated by at most 3 inches of space), certain networks dependent upon these facts may be utilized. For example, vibrations may be created by a mechanical motor and transmitted through its physical connections to other physical assets. It is possible to model a vibration network for analysis. Similar networks may be modeled for heat (temperature), moisture, light, sound, gases, etc. Each of these additional networks may be represented by their own set of relationship types. For example, a node representing a pump may have a relationship with the label CONNECTED_PHYSICALLY between the pump node and a pipeline node as illustrated in FIG. 11. Another relationship for TRANSMITS_VIBRATIONS may be added between the pump node and the pipeline node, as illustrated in FIG. 11. A TRANSMITS_FLUID relationship may be added at a later point in time between the pump node and the pipeline node, as illustrated in FIG. 11. The functional connection between the two physical devices could be analyzed, and magnitudes or other metrics assigned to each of these relationships, to better facilitate their use.

At step 715, the method 700 comprises connecting the physical asset tier and the P&ID tier to update the multi-tier facility knowledge graph for the facility, wherein the P&ID tier comprising the P&ID tier serves as a control structure for the multi-tier facility knowledge graph. The P&ID tier and the physical asset tier may be connected to generate the multi-tier facility knowledge graph for the facility by connecting tag-based objects with physical assets. However, it is worth noting that the physical asset tier does not contain tags, as the tags are primary identifiers in the P&ID tier. This is to keep these abstraction levels separate from one another. Separate tiers are useful because at least one physical asset of the facility may be replaced without changes to the functional design. As an example, a pump from one manufacture with one set of performance characteristics and maintenance requirements may be replaced by a pump from another manufacture with another set of performance characteristics and maintenance requirements as long as both are compatible with the functional requirements. In the process of replacing one physical pump with another, the tag does not change, nor have the functional requirements for the equipment, even though the equipment itself is wholly different. The operation to connect nodes in the P&ID tier with nodes in the physical asset tier may be expedited through the use of computer systems which implement the Capital Facilities Information Handover Standard (CFIHOS). CFIHOS-compliant systems maintain a clear differentiation between tags which represent specific process unit functions, and equipment which is a physical device that performs a function. (see “CFIHOS—Scope and Procedure” document page 19). A CFIHOS-compliant system may be used to create the necessary relationships between the P&ID tier and the physical asset tier.

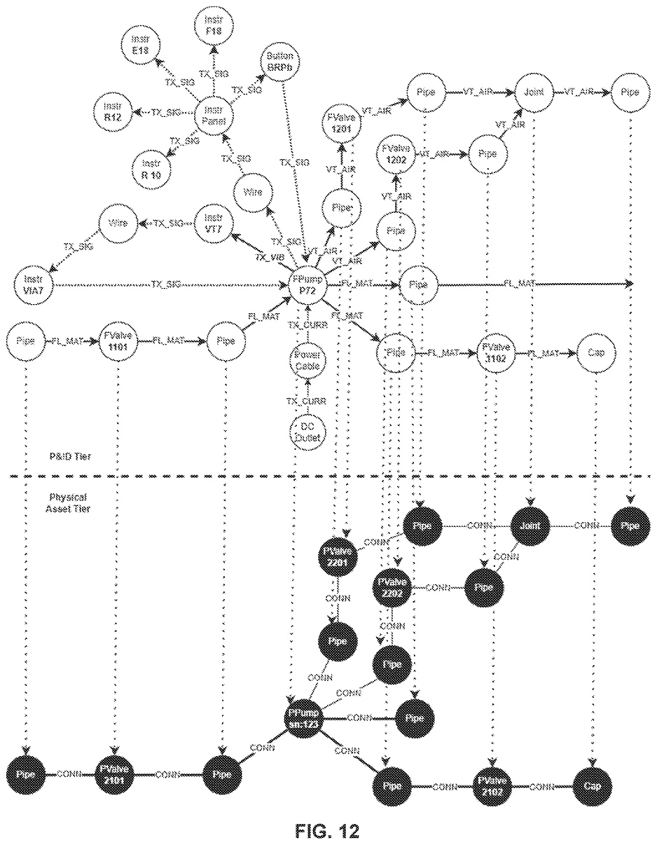

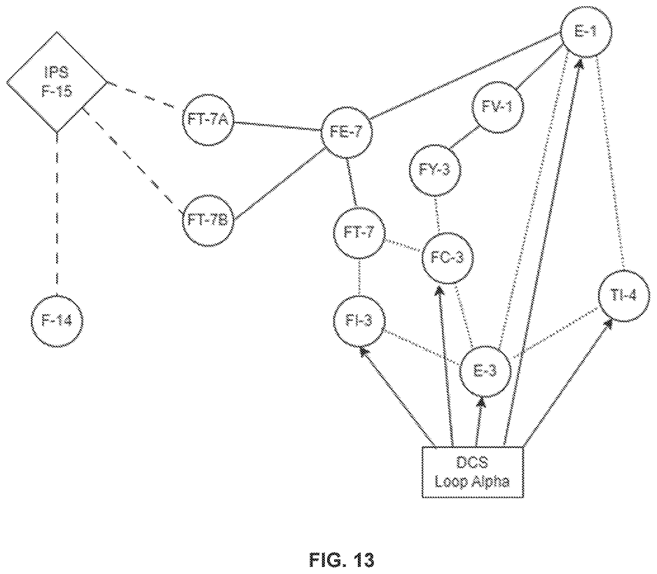

FIG. 12 illustrates a non-limiting example of a multi-tier facility knowledge graph with a non-limiting P&ID tier and a non-limiting physical asset tier connected by tag to physical asset relationships. The top part of the diagram is a graph of the P&ID data representing the functional parts of the facility. The bottom part of the diagram is the Physical Asset graph representing the actual equipment which is physically installed to perform the function. The dotted relationships from the P&ID nodes to the Physical Asset nodes are IMPLEMENTED BY relationships which connect the function to its implementing asset. This is strongly aligned with the CFIHOS distinction between Tags and Equipment and supports replacement of equipment without altering the Tag. This figure corresponds to the description of a “tag to physical asset” relationships.

The multi-tier facility knowledge graph may include at least one additional tier, such as, but not limited to, a simulation tier. Optionally, at step 720, the method 700 comprises obtaining simulation data for the facility and generating a simulation tier responsive to the obtained simulation data for the facility. The step also comprises connecting the simulation tier and the P&ID tier to update the multi-tier facility knowledge graph for the facility. The connecting of the simulation tier to the P&ID tier isn't governed by a standard such as CFIHOS. Further complicating the matter, there are a variety of simulation software products and they are not uniform in their definition of model elements. However, there are a limited number of elements which are used in simulation software, just as there are a limited number of elements used in P&IDs. These can be aligned with one another in a lookup table and the relationships between the two tiers established based on the lookups, with validation by a subject-matter expert. It is also possible to programmatically generate simulation models from the P&ID data based upon the same lookup values. For these programmatically generated simulation models, part of the generation process would include the definition of the relationships connecting the generated simulation model to the source P&ID data. The multi-tier facility knowledge graph comprises a simulation tier comprising the simulation data and networks for both process and mechanical simulation models.

Simulations are designed to model physical phenomena, such as changes in a process (e.g., separation process in the facility, heating process in the facility, cooling process in the facility, fluid flow process, etc.), for example, in response to changes in physical assets, changes in values of parameter, etc. Simulations are typically computationally intensive, and as such, individual simulations may focus on specific subsystems in the facility. This utilizes certain additional abstractions and sometimes even the insertion of equipment placeholders to accomplish the goals of a simulation. These additional abstractions, such as an incoming stream of material or simulation-specific equipment, may be additions present in the process tier of the multi-tier facility knowledge graph. For example, the process tier may also have some additional abstractions, like simulation-specific nodes and relationships. This would facilitate having multiple disjoint simulations represented with their own simulation data.

The simulation tier may include two useful options. First, code and configuration present within the simulation software may be translated into simulation data and made part of the simulation tier of the multi-tier facility knowledge graph. This would allow the simulation data to be combined with the information about the functional design of the facility (the P&ID tier of the multi-tier facility knowledge graph) and with specific details about the exact physical assets in use (the physical asset tier of the multi-tier facility knowledge graph). Each of the additional tiers supports additional insights, shortening analysis times, and reducing errors. The traditional approach of staff combining data on their own may be replaced by pre-combined, pre-joined data of the multi-tier facility knowledge graph.

Second, multiple simulation configurations and results may be present in the multi-tier facility knowledge graph at the same time. This is a function of any graph data structure's ability to establish several many-to-many relationships and efficiently filter between the relationships when traversing the knowledge graph and leveraging simulation tier networks and connecting that to physical asset and P&ID tier networks. This functionality supports efforts by staff to analyze the facility design and operations simultaneously under different conditions or selecting the most closely aligned conditions for contextual analysis.

The simulation tier may make use of nodes from other tiers as it utilizes both physical capabilities of the physical assets of the physical asset tier as well as the functional design of the P&ID tier. As the simulation models for the specific physical equipment there is an advantage in using a node from the physical asset tier in the simulation tier as well. Also, in the same way that the physical representation of the equipment may be enhanced with the contextual information from the P&ID tier through the connection of tags to equipment, the simulation can similarly be enhanced, and directly connected to both the physical representation as well as the functional. This direct connection within the data itself reduces the complexity of translating simulation data and details to other tiers, thereby both decreasing the risk for errors and shortening the feedback loops between various staff roles. Shorter feedback loops lead to faster iterations and more rapid development of insights from the data to make engineering decisions for facility operation and planning.

The multi-tier facility knowledge graph may include at least one additional tier, such as, but not limited to, an organization tier. Therefore, optionally, at step 725, the method 700 comprises obtaining organization data for the facility and generating an organization tier responsive to the obtained organization data for the facility; and connecting the organization tier and the P&ID tier to update the multi-tier facility knowledge graph for the facility. These types of connections will be established based on business documents and rules aligning the facility assets with the organizational hierarchy of the enterprise. Because companies change their organizational structure at a rate different from the creation or retirement of facilities, it is important to separate these tiers. The multi-tier facility knowledge graph comprises an organization tier comprising organization data. The organization data may include roles and responsibilities, personas, access control, organization structure and reporting.

Physical assets and their functional purposes may outlast a given approach to organizing a company into business units, divisions, departments, etc. Knowledge of the owning department, business unit, division, etc. may be useful for identifying decision-making responsibility or making accounting allocations. Physical assets and businesses may operate with differing lifecycles. Additionally, different wells, refineries, etc. may be owned by different business units, and an organizational representation may clarify and quantify the interactions between business units. For example, in the context of large multi-national enterprises, the organization tier may be intersected with a geospatial data to facilitate reporting by both business units and geographic locations.

As such, it may be useful to model this type of data as an organization tier in the multi-tier facility knowledge graph. The organization tier may include nodes and edges related to organizational structure. ISO 14224:2016 (E) may be utilized for the organization tier as defined at Level 1, 2 and 3 as illustrated in the non-limiting example in TABLE_2 below:

TABLE 2

| | | | |
|---|---|---|---|
| | Data Standard | | Example |
| Level | Classification | Node Category | Data |

| | | |
|---|---|---|
| 1 | Industry | Enterprise |
| 2 | Business Category | BU |
| 3 | Installation | Refinery/Facility Location |
| 4 | Plant/unit | Plant/Unit |
| 5 | Section/System | Unit Section/system |
| 6 | Equipment Unit | Equipment Unit |
| 7 | Subunit | Subunit |
| 8 | Component/ | Object/Equipment/ |
| | Maintainable Item | Instrumentation |
| 9 | Part | |

The organization tier may further be utilized to roll-up all the facility data across the entire enterprise to support analysis such as “How many pumps does the enterprise have in operation in each business unit?”

The multi-tier facility knowledge graph may include at least one additional tier, such as, but not limited to, an economic tier. Optionally, at step 730, the method 700 comprises obtaining economic (e.g., financial and operating) data for the facility and generating an economic tier responsive to the obtained economics data for the facility; and connecting the economic tier and the P&ID tier to update the multi-tier facility knowledge graph for the facility. Operating data will often be generated by instruments defined in the P&ID and recorded as timeseries data. The timeseries data systems have labels which align directly with the tag values in the P&ID tier, though sometimes a subject-matter expert must validate or correct erroneous matches if the timeseries label was not configured properly. Financial data such operating costs or original capital expenditures are available from various data sources of origin include purchase orders, maintenance records, and manufacture documentation. The multi-tier facility knowledge graph comprises an economic tier comprising the economic tier. The financial data may include cost of materials, equipment, maintenance costs as well pricing and forecast accounting for the facility used for supply and trading transactions.

In the discussion so far, the following four tiers have been defined: (a) P&ID tier for the functional operation of the facility based on the P&ID diagrams, (b) Physical asset tier for the physical assets based on the asset hierarchy, Simulation tier for precise chemistry and physics computations, and (d) Organization tier for the organizations legal and decision-making structure. However, these four tiers may not consider an important dimension of a commercial enterprise: the financial dimension. Thus, the multi-tier facility knowledge graph may be extended with an additional tier, such as an economic tier.

There may be a natural division in corporate accounting between capital expenditures and operating ones. These could be separated into different networks within the economic tier to facilitate the differences in tax and other accounting operations. A capex network in the economic tier may link up with the physical tier and may track with its changes. In comparison, an opex network in the economic tier may connect not only with the physical tier in tracking of operating expenses, but it could connect as well with the simulation tier and the P&ID tier to add a financial component in the efforts to optimize production for the facility.

Although five tiers have been discussed herein, a person of ordinary skill in the art may appreciate that one or more additional tiers may be connected to the P&ID knowledge graph. Additionally, the simulation tier, the organization tier, and/or the economic tier are optional.

Moreover, one or more tiers may be extended, for example, with at least one network. A tier may include multiple networks as several domains may operate at the same abstraction level. Subdividing a tier into networks provides several advantages. At the start, by defining a network and associating it with a subject domain or type of system, that network becomes an encapsulation of the representation of that subject domain. This allows application developers and others constructing solutions with the multi-tier facility knowledge graph to focus their attention on a particular part of the multi-tier facility knowledge graph. Networks then become a convenient way to filter the data in the multi-tier facility knowledge graph either for specific use cases or for specific personas.

As an example, an instrumentation network in the P&ID tier will be discussed further. Data may be collected from instruments throughout the facility in the form of timeseries, and the collected data may be regularly combined for analysis and correlation. Traditional technologies are limited in how they may combine these streams of observations. Instrument management systems may have a logical construct, normally called a loop, and a facility may have multiple loops, sometimes with dependencies between loops. There are also different types of loops, such as an Instrumented Protective System (IPS) loop. FIG. 13 illustrates a non-limiting example of instruments combined with loops and an IPS,

In one embodiment, instruments may be represented both in the P&ID tier's instrumentation network and in the physical asset tier's asset hierarchy network, so some of the nodes may be reused in an instrumentation network. The key addition at this network is the definition of the collections (loops), the relationships between the loops, and the various control systems (i.e., Dedicated Control System (DCS)) along with the dependency relationships between the loops. It is these additional types of nodes combined with the instrumentation-specific relationships which define the instrumentation network.

Optionally, at step 735, the method 700 comprises obtaining a query (e.g., from a user or some other computer program); traversing the multi-tiered knowledge graph for the facility to collect data from the multi-tiered knowledge graph for the facility to answer the query; and generating a response to the query using the collected data from the multi-tiered knowledge graph for the facility.

Regular maintenance operation includes the replacement of mechanical devices such as pumps which degrade over time from constant use. For example, the facility operator has determined that the pump for tag P72 must be replaced. It uses the multitiered facility graph to determine that the serial number for the installed pump is 123. To replace pump 123, all upstream valves must be closed so that the pump can be turned off safely, but downstream valves should remain open to drain safely the material from the pump. The physical asset tier cannot be used to determine which valves to close because its CONN relationships are without direction. The P&ID tier provides the functional understanding of the facility. Also, it is only important to close values which control the flow of materials. Valves used for ventilation should remain open during the operation. From this the planner determines that the only value which is upstream from the pump is the FValve (functional valve) 1101. Functional valves 1201 and 1202 are used for ventilation and functional valve 1102 is in the downstream direction. He is also able to disregard the relationships with the TX_SIG (transmit signal) and TX_CURR (transmit current) labels since those do not represent the flow of materials through the pump.

A query using the Cypher query language for this type of analysis could look something like the following:

MATCH (fp:FPump)<-[:FL_MAT*]<-(fv:FValve)-->(pv:PValve)
WHERE fp.tag = ‘P72’
RETURN fv, pv

This query returns the details for the functional valve 1101, which will help the operator when they review the P&ID for the work. It will also return the details for the physical asset, valve 2101 which will include important physical characteristics of the valve such as the required torque to open or close the valve. The results will not include any of the other valves because the query specifies both the type (FL_MAT) and direction (upstream) of the relationships to traverse in the graph.

As a final note, querying data in this fashion can be more precise and therefore more safe than visual inspection of a P&ID. The P&ID doesn't have consistent indication of direction or types of connections. The P&ID in the figures illustrate that there are 8 connections to the pump P72 but only a couple have arrowheads to indicate direction. A misreading of the P&ID could result in faulty conclusions by an operator and a riskier plan. The multitiered facility graph representation of the P&ID data is more precise and also includes the physical asset details necessary to complete the operation safely.

Optionally, at step 740, the method 700 comprises generating a visual representation for the response to the query that was generated by traversing the multi-tiered knowledge graph for the facility; and displaying the visual representation via a display. The P&ID tier contains the information necessary to dynamically construct accurate P&ID diagrams of the facility. This present invention doesn't require that the dynamically rendered P&ID match pixel for pixel, or dot for dot, the original diagram. But it has sufficient information necessary to represent all of the symbols and objects. Also, because it has access to the physical tier which can include 3D model details, precise physical dimensions, geospatial locations, and physical connectivity information, it is possible also to render a 3D model of the physical assets to match the P&ID which is dynamically created. These two images of the facility, the dynamically created P&ID and the 3D model can be displayed side-by-side on a computer display providing a simultaneous functional and physical view of a facility system. In some embodiments, generating and displaying the visual representation for the response to the query includes generating and displaying at least a portion of the multi-tiered knowledge graph for the facility in the response to the query.

Optionally, at step 745, the method 700 comprises obtaining a subgraph of the multi-tiered knowledge graph for the facility; and combining the subgraph with other data that is external to the multi-tiered knowledge graph for the facility (e.g., to perform computational analysis (e.g., cost avoidance, operational improvements, production optimization). A user may say show me a particular subsystem (cooling system, ventilation system or other system larger than a single P&ID) of the facility. The subgraph of the subsystem is obtained from the multi-tiered knowledge graph of the facility, and the subgraph may be combined with maintenance data to do analysis and make decision about the subsystem or the facility, or both like swap out subsystem or tweak value and improve performance or reduce risk.

The multi-tier facility knowledge graph (MTFKG) may significantly reduce the cost and complexity to represent functional portions of a facility. Some systems within the facility span multiple P&ID diagrams. With the MTFKG a system can be defined based on the data, specifically based on connection types and directions in the data. For example, it is possible to dynamically define a subgraph or special-purpose network based on a type of relationship and direction. An operator who is noticing that one pump in a parallel series of pumps is performing below its optimal range, but the other pumps in the series are all within their optimal range. That operator can then define a query which collects all instruments upstream of the pumps' input ports and flag the ones which are exclusively upstream of the poor performing pump. This defines two subgraphs of instruments, one exclusive to the poor performing pump and all other instruments which are upstream of all pumps. From these two subgraphs, the timeseries data can be collected from a data store external to the MTFKG and analyzed against each other to determine the source of the poor performing pump's performance problems.

Optionally, at step 750, the method 700 comprises obtaining process control loop data (e.g., DCS is distributed control system, IPS which is integrated/industrial process system, SPI data/data store for operating or management of the facility) for a subset of instruments in the facility (e.g., of the P&ID knowledge graph); and extending the multi-tier facility knowledge graph (e.g., P&ID tier) responsive to the obtained process control loop data (e.g., to add extra nodes and edges to the P&ID knowledge graph).

Optionally, at step 755, the method 700 comprises obtaining maintenance data for a subset of equipment in the facility; and extending the multi-tier facility knowledge graph responsive to the obtained maintenance data (to add extra nodes and edges to the equipment knowledge graph). It is a common practice to build a new data store using current values. But this can leave behind historical context which can be helpful for ongoing facility operations. Maintenance data is inherently historical, recording previous events such as the replacement of equipment. It will also include references both to specifics of physical equipment (e.g., serial number, installation date, removal date) as well as references to the tag for the equipment. From these details, historical data can be added to the MTFKG to reflect not only the changes of equipment but the sequence of the changes by creating a linked-list data structure with NEXT and PREVIOUS relationships that also contain start date and end date properties. This extension of the MTFKG with time-versioning functionality can simplify and speed up efforts to explain inconsistencies in historical timeseries data for instruments connected to swapped-out equipment.

Optionally, at step 760, the method 700 comprises processing data (e.g., quality, validation, and/or mastering, such as the P&ID data and/or equipment data for the facility) before generating the multi-tier facility knowledge graph (e.g., before generating the P&ID tier), and wherein the processed data is utilized for generating the multi-tier facility knowledge graph.

Traditionally, it would likely be a complex and manual task for a user to bring together the observational data from multiple loops, map out their dependencies, and complete the analysis. But when all this data is present in a knowledge graph and connected to the functional P&ID data and the physical representation as discussed herein, then the user may have what they need in one place. Furthermore, instead of using simple or flat representations of the connections between devices and instruments, with the graph representation, a more nuanced analysis may be possible based on the networked relationships. Conceptually, for example, a user may want to collect the instrumentation data in the multi-tier facility knowledge graph up to 3 hops downstream from a certain device. Traditionally, it would not be possible to determine upstream/downstream direction without the functional P&ID data, nor count the number of hops. The multi-tier facility knowledge graph turns this arduous, manual data collection task on the part of the user into a succinctly expressed (with modern graph query languages) and quickly executed query.

The generated multi-tier facility knowledge graph for the facility may be utilized for a variety of purposes, such as those described herein and potentially others. Advantageously, besides the tag referencing capability, one of the key capabilities of the multi-tier facility knowledge graph is that it takes information resident only in experts' minds and materializes it in the multi-tier facility knowledge graph as relationships. Making this knowledge into data may reduce the number of engineering discipline experts who must be consulted to answer a particular question (as well as reduce the delay and cost for the same).

This is an additive capability. The multi-tier facility knowledge graph may start by representing a single engineering discipline with a focused set of use cases. Over time, more engineering disciplines may be added as the data matures and users gain confidence in the effectiveness of the multi-tier facility knowledge graph.

Advantageously, another capability is that the multi-tier facility knowledge graph is immediately available. At present, operators would have to invest time in order to make a built-for-purpose data set to answer their questions. These ad hoc data sets may be used for one question and then discarded because they will be out of date the next time they are consulted, since there is no process to maintain them. But with an actively maintained multi-tier facility knowledge graph, the data may be immediately available and may be already up to date. Not only does this avoid the cost of building a bespoke data set, but since it is maintained through standard processes, there is a higher confidence in the accuracy of the data.

Advantageously, machine learning (ML) operations may no longer be limited to directly connected data series. With the complex topology of the multi-tier facility knowledge graph, increasingly sophisticated production optimization computations become possible. This is due to the presence of multiple tiers representing multiple critical dimensions to include in the analysis. The methods and systems of the present disclosure may, in part, use one or more models that are machine-learning algorithms. These models may be supervised or unsupervised. Supervised learning algorithms are trained using labeled data (i.e., training data) which consist of input and output pairs. By way of example and not limitation, supervised learning algorithms may include classification and/or regression algorithms such as neural networks, generative adversarial networks, linear regression, etc. Unsupervised learning algorithms are trained using unlabeled data, meaning that training data pairs are not needed. By way of example and not limitation, unsupervised learning algorithms may include clustering and/or association algorithms such as k-means clustering, principal component analysis, singular value decomposition, etc. Although the present disclosure may name specific models, those of skill in the art will appreciate that any model that may accomplish the goal may be used.

Advantageously, more sophisticated production optimization techniques may be utilized, for example, as there are more tiers available for analysis. ML operations across increasingly complex topologies of connections may be utilized.

Advantageously, the multi-tier facility knowledge graph may simplify basic dependency analysis, for example, functionally what is upstream from a mis-behaving device, and for example, may be able to isolate that to physically connected items and/or. further isolate to specific types of networks or inputs.

Advantageously, the multi-tier facility knowledge graph may be utilized in the areas of: Profit, Draw (e.g., Engineering Control, Harmonization, Facility Graph, etc.), more complex simulations support better predictability of the consequences of changes that incorporates P&ID, simulation and physical tiers, ability to traverse using multiple tiers, problem solving w/shortest path, etc.

Advantageously, the multi-tier facility knowledge graph may provide a unique and distinguishing combination of data from various sources depicting oil and gas facilities at different abstraction levels. By combining the different taxonomies into a single multi-tier facility knowledge graph, users may approach the part of the data which is most relevant to them and disregard, or selectively include, the other parts.

Advantageously, a design parameter may be implemented or adjusted in the facility based on the multi-tier facility knowledge graph. Advantageously, an operating parameter may be implemented or adjusted in the facility based on the multi-tier facility knowledge graph. The parameters may be total flow, conductivity, etc.

Advantageously, a design parameter may be implemented or adjusted for a wellbore (e.g., a wellbore connected to the facility) based on the multi-tier facility knowledge graph. Advantageously, an operating parameter may be implemented or adjusted for a wellbore (e.g., a wellbore connected to the facility) based on the multi-tier facility knowledge graph.

More information may be found in the following items, each of which is incorporated by reference:

| ISO 14224: 2016(E) | https://www.iso.org/standard/64076.html |
|---|---|
| ISO 19008 | |
| ISO 81346 | |
| CFIHOS | https://www.jip36-cfihos.org/cfihos-standards/ |
| Data Exchange | https://dexpi.org/ |
| in the Process | |
| Industry (DEXPi) | |
| U.S. Pat. No. | |
| 11,295,123 | |

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of generating a multi-tier facility knowledge graph for a facility, the method comprising:
obtaining P&ID data for the facility and generating a P&ID knowledge graph responsive to the obtained P&ID data for the facility, wherein the P&ID knowledge graph serves as an originating P&ID tier in the multi-tier facility knowledge graph for the facility;
obtaining physical asset data for the facility and generating a physical asset tier responsive to the obtained physical asset data for the facility; and
connecting the physical asset tier and the P&ID tier to update the multi-tier facility knowledge graph for the facility, wherein the P&ID tier comprising the P&ID knowledge graph serves as a control structure for the multi-tier facility knowledge graph.

2. The method of claim 1, further comprising:
obtaining simulation data for the facility and generating a simulation tier responsive to the obtained simulation data for the facility; and
connecting the simulation tier and the P&ID tier to update the multi-tier facility knowledge graph for the facility.

3. The method of claim 1, further comprising:
obtaining organization data for the facility and generating an organization tier responsive to the obtained organization data for the facility; and
connecting the organization tier and the P&ID tier to update the multi-tier facility knowledge graph for the facility.

4. The method of claim 1, further comprising:
obtaining economic data for the facility and generating an economic tier responsive to the obtained simulation data for the facility; and
connecting the economic tier and the P&ID tier to update the multi-tier facility knowledge graph for the facility.

5. The method of claim 1, further comprising:
obtaining a query;
traversing the multi-tiered knowledge graph for the facility to collect data from the multi-tiered knowledge graph for the facility to answer the query; and
generating a response to the query using the collected data from the multi-tiered knowledge graph for the facility.

6. The method of claim 5, further comprising:
generating a visual representation for the response to the query that was generated by traversing the multi-tiered knowledge graph for the facility; and
displaying the visual representation via a display.

7. The method of claim 6, wherein generating and displaying the visual representation for the response to the query includes generating and displaying at least a portion of the multi-tiered knowledge graph for the facility in the response to the query.

8. The method of claim 1, further comprising:
obtaining process control loop data; and
extending the multi-tier facility knowledge graph responsive to the obtained process control loop data.

9. The method of claim 1, further comprising:
obtaining maintenance data for a subset of equipment in the facility; and
extending the multi-tier facility knowledge graph responsive to the obtained maintenance data.

10. The method of claim 1, further comprising processing data before generating the multi-tier facility knowledge graph, and wherein the processed data is utilized for generating the multi-tier facility knowledge graph.

11. The method of claim 1, further comprising:
obtaining a subgraph of the multi-tier facility knowledge graph; and
combining the subgraph with other data that is external to the multi-tier facility knowledge graph.

12. A computer system, comprising:
one or more processors;
memory; and
one or more programs, wherein the one or more programs are stored in the memory and configured to be executed by the one or more processors, the one or more programs including instructions that when executed by the one or more processors cause the system to generate a multi-tier facility knowledge graph for a facility, the method comprising:
obtaining P&ID data for the facility and generating a P&ID knowledge graph responsive to the obtained P&ID data for the facility, wherein the P&ID knowledge graph serves as an originating P&ID tier in the multi-tier facility knowledge graph for the facility;
obtaining physical asset data for the facility and generating a physical asset tier responsive to the obtained physical asset data for the facility; and
connecting the physical asset tier and the P&ID tier to update the multi-tier facility knowledge graph for the facility, wherein the P&ID tier comprising the P&ID knowledge graph serves as a control structure for the multi-tier facility knowledge graph.

13. The system of claim 12, further comprising:
obtaining simulation data for the facility and generating a simulation tier responsive to the obtained simulation data for the facility; and
connecting the simulation tier and the P&ID tier to update the multi-tier facility knowledge graph for the facility.

14. The system of claim 12, further comprising:
obtaining organization data for the facility and generating an organization tier responsive to the obtained organization data for the facility; and
connecting the organization tier and the P&ID tier to update the multi-tier facility knowledge graph for the facility.

15. The system of claim 12, further comprising:
obtaining economic data for the facility and generating an economic tier responsive to the obtained simulation data for the facility; and
connecting the economic tier and the P&ID tier to update the multi-tier facility knowledge graph for the facility.

16. The system of claim 12, further comprising:
obtaining a query;
traversing the multi-tiered knowledge graph for the facility to collect data from the multi-tiered knowledge graph for the facility to answer the query; and
generating a response to the query using the collected data from the multi-tiered knowledge graph for the facility.

17. The system of claim 16, further comprising:
generating a visual representation for the response to the query that was generated by traversing the multi-tiered knowledge graph for the facility; and
displaying the visual representation via a display.

18. The system of claim 17, wherein generating and displaying the visual representation for the response to the query includes generating and displaying at least a portion of the multi-tiered knowledge graph for the facility in the response to the query.

19. The system of claim 12, further comprising:
obtaining process control loop data; and
extending the multi-tier facility knowledge graph responsive to the obtained process control loop data.

20. The system of claim 12, further comprising:
obtaining maintenance data for a subset of equipment in the facility; and
extending the multi-tier facility knowledge graph responsive to the obtained maintenance data.

21. The system of claim 12, further comprising processing data before generating the multi-tier facility knowledge graph, and wherein the processed data is utilized for generating the multi-tier facility knowledge graph.

22. The system of claim 12, further comprising:
obtaining a subgraph of the multi-tier facility knowledge graph; and
combining the subgraph with other data that is external to the multi-tier facility knowledge graph.
